(19) United States
(12) Patent Application Publication
(10) Pub. No.: US 2010/0156620 A1
(43) Pub. Date: Jun. 24, 2010

(54) VEHICLE REAR SAFETY DISTANCE ALERTING SYSTEM

(76) Inventors: Sohail Shams, Kirkland, WA (US); Alexander Wang, Woodinville, WA (US)

Correspondence Address: Sohail Shams, 10034 NE 139th St., Kirkland, WA, 98034, US

(21) Appl. No.: 12/343,503

(22) Filed: Dec. 24, 2008

(51) Int. Cl. B60Q 1/54

(52) U.S. Cl. 340/466

(57) ABSTRACT

A device would be installed in the rear of an automobile to help cultivate better driving habits. The habit in question is tailgating (following too closely). Once installed, the device is activated automatically when the car following the subject car is not keeping its proper distance with subject car without the necessity of any input from the driver of the subject car. Once activated the device communicates with the driver of the car following the subject car through visual and other means to help maintain a safer following distance.

This device will gauge the speed and distance between the subject car and the car following it, and signal the driver of the following car to adjust the distance for a safer commute. This will be accomplished by a signaling system to the driver of the following car by visual or mechanical means.

A device will be installed in the rear of an automobile, on its own and or in collaboration with other existing products and technologies to help cultivate better driving habits. The habit in question is tailgating (following too closely), (apparently, the improper following distance is the cause for a large percentage of the rear end accidents causing personal injury and property damage). The aim of this device therefore is to reduce the risk by bringing awareness to drivers everywhere.

The Rear portion of this device will communicate to the driver of the car following the subject car via visual, mechanical and or a combination of visual and mechanical means. The signals communicated to the driver of the car following the subject car, will be one of pulsating, rhythmic flashing of the third light (or other lights), much the same as the pulsating, rhythmic flashing lights of an emergency vehicle (police, utility, hwy dept.). The flashing, rhythm will be programmed based on the speed of the subject car, speed of the car following the subject car, and their distance from each other at any particular time (the rhythm and flashing of the light (s) will increase with the decrease of the distance between the car following the subject car and the subject car, indicating the degree of urgency with which a following distance adjustment is recommended). The only evidence of the installed device for the driver of the subject car will most probably be an indicator light to signal that it is working properly or not and the other, a switch or a button to reset it for different weather conditions (probably two settings, one for good and the other bad weather conditions). Considerations for the general programming and design of this device should include:

1—A 2-3 second delay before the device is activated when it is has been tripped.

2—When the car following the subject car starts adjusting its position (increases the distance and or reduces its speed or both), that the device should become inactive again. The 2-3 second delay and the default programming for the device to become inactive when the distance or speed adjustment has started by the driver of the car following the subject car, is to prevent an overload of, and the unnecessary signaling (distraction) of the driver or the drivers following the subject car.

3—Appropriate design features should be considered, for the sensors (speed and distance) so that they are not easily interfered with due to blocking debris, accessibility to alter or interfere with and malfunction due to poor design.

### SYSTEM DESCRIPTION

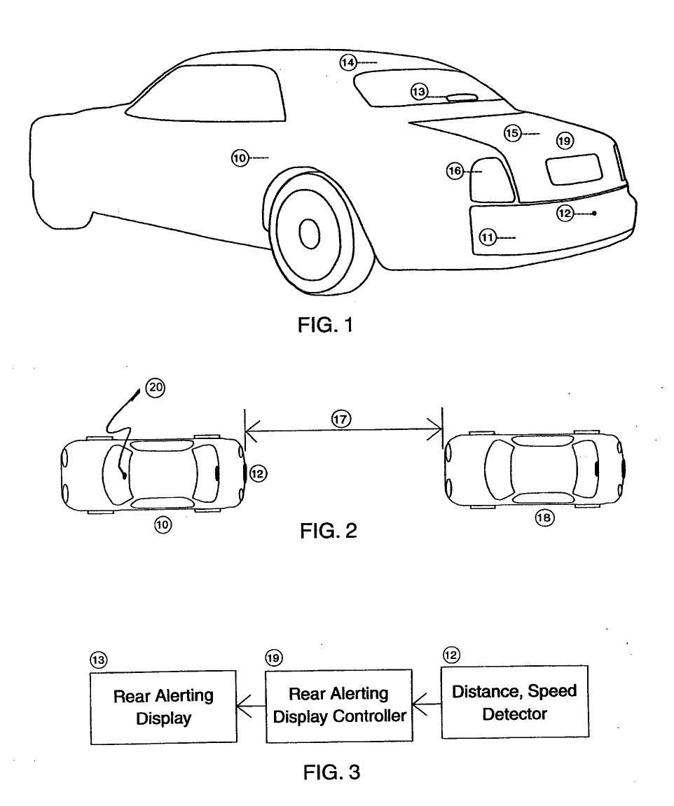

FIG. 1 It shows the rear part of a vehicle (10) which is equipped with the (Vehicle Rear Safety Distance Alerting System).

A Distance, Speed Detector (“the Detector”) (12) can be mounted on, or installed anywhere of the rear ( meaning all parts visible to the driver of the vehicle following the subject car) of the vehicle (10), e.g. the rear bumper (11), top of the trunk (15), top of the cab (14), inside the cab towards the rear widow and or close to the third light (13) etc., facing the vehicle following the subject car (18). The Detector will apply the technology of radio-frequency (RF) and, or optics (visible or non-visible) to detect the distance (17) (shown in FIG. 1), the speed of the vehicle following the subject car (18) and/or the speed difference (relative speed) between vehicles (10) and (18) (shown in FIG. 2).

A Rear Alerting Display (“the Display”) (13) of various designs: display sizes, shapes and combinations of lighting patterns, which provides visual alert to the vehicle following the subject car, vehicle (18), can be mounted anywhere on the rear portion of the subject vehicle (10) facing the vehicle following the subject car, vehicle (18). It can be on top of the trunk (15), on top of the cab (14) and or integrated with, or near the existing brake lights (13) & or (16).

An indicator light (20) is installed near the subject car's driver which shows whether the device is functioning properly or not. There is also a button or a switch close or next to this indicator which allows the device to be reset for weather conditions.

It shows the functioning relationship between the 3 major components: the Distance/Speed Detector (“the Detector”) (12), Rear Alerting Display Controller (“the Controller”) (19), and the Rear Alerting Display (“the Display”) (13). The Controller, which can be integrated with the Detector or installed separately inside the vehicle, receives the measurements of the distance, and speed from the Detector (12) and when tripped, activates the Display with different patterns (i.e. different flashing rates) based on the distance between the subject vehicle and the vehicle following the subject vehicle and their speed (flow of traffic and or their relative speed).

1. A Rear Visual Alerting system: factory integrated as part of the subject car, or manufactured separately and installed or, integrated later with the subject car. Said device is of various designs: display sizes, shapes and combinations of lighting patterns, which provides a visual alert to the vehicle following the subject car, can be mounted anywhere on the rear portion of the subject vehicle (,meaning all parts visible to the driver of the vehicle following the subject car).
